(19) United States
(12) Patent Application Publication
(10) Pub. No.: US 2005/0212400 A1
(43) Pub. Date: Sep. 29, 2005

(54) Arc tube having reduced length, low-pressure mercury lamp, and lighting apparatus

(76) Inventors: Shiro Iida, Kyoto-shi (JP); Noriyuki Uchida, Hirakata-shi (JP); Hidezoh Akutsu, Kobe-shi (JP)

Correspondence Address: SNELL & WILMER L.L.P., 1920 MAIN STREET, SUITE 1200, IRVINE, CA, 92614, US

(21) Appl. No.: 11/075,969

(22) Filed: Mar. 9, 2005

(30) Foreign Application Priority Data
Mar. 23, 2004 (JP) 2004-085365

(51) Int. Cl. H01J 1/62

(52) U.S. Cl. 313/493; 313/634

(57) ABSTRACT

A low-pressure mercury lamp has: an arc tube formed by an arc-tube body in helical configuration, and electrodes provided at respective ends of the arc-tube body; and bases supplying power to the electrodes. The arc-tube body is made of a glass tube winding around an axis A while moving into a direction of the axis A. Ends of the glass tube are positioned away from each other with the winding part therebetween in the direction of the axis A. An outer diameter of the winding part seen in the direction of the axis A is within a range of 16 mm to 38 mm.

This application is based on application No. 2004-85365 filed in Japan, the contents of which are hereby incorporated by reference.

### BACKGROUND OF THE INVENTION

(1) Field of the Invention

The present invention relates to an arc tube having electrodes provided at both ends of the body of the arc tube. The present invention also relates to a low-pressure mercury lamp employing the arc tube, and to a lighting apparatus employing the low-pressure mercury lamp.

(2) Related Art

Recently, with a view toward protecting the global environment, there is need to achieve improved energy efficient and reduced size of lamps in the lighting field. Attempts are also being made to increase the efficiency and reduce the size of low-pressure mercury lamps conventionally used in general lighting. If attempts to make small lamps succeed, industrial wastes will be eliminated.

For example, in a fluorescent lamp using a straight arc tube (hereinafter called “straight-tube fluorescent lamp”), high efficiency and size reduction have been achieved by adoption of a thinner tube for the arc tube, and by improvement of the light ballast that lights the straight-tube fluorescent lamp. Specifically, improving the light ballast involves a change from using a conventional copper/iron ballast to using an electronic ballast containing an inverter circuit unit. With such an improvement, high frequency lighting has become possible.

With regard to the adoption of a thinner tube, in a straight-tube fluorescent lamp adopting a conventional copper/iron ballast (so-called rapid start type), the outer diameter of the arc tube is 32.5 mm. Compared to this, in a straight-tube fluorescent lamp adopting an electronic ballast that has become the current mainstream (so-called Hf-type), the outer diameter of the arc tube is 25.5 mm, which is about a 7-mm reduction compared to the conventional case.

As for the lamp efficiency, for a straight-tube fluorescent lamp of a conventional rapid start type of 20 W, luminous flux is 1230 lm, and lamp efficiency is 61.5 lm/W. On the other hand, for a straight-tube fluorescent lamp of a 16 W Hf type (an alternative to the straight-tube fluorescent lamp of a rapid start type), luminous flux is 1470 lm, and lamp efficiency is 91.9 lm/W, exhibiting great efficiency improvement. Note that very recently, an even more slim straight-tube fluorescent tube has been developed whose outer diameter of its arc tube is as thin as 16 mm.

Various types of arc tubes respectively employing a body formed by bending a glass tube into double helical configuration have also been conventionally proposed. However, none of them has been used as an alternative to a conventional straight-tube fluorescent lamp (e.g. please refer to “Japanese laid-open utility model application No. S61-144561, and Japanese laid-open patent application No. H09-69309).

Meanwhile, although success has been achieved in HF fluorescent lamps in terms of adopting a thinner tube and heightening efficiency compared to a conventional rapid start type, the length of the tube has not been significantly reduced in comparison to a conventional rapid start type, nor has the overall size of HF fluorescent lamps been sufficiently reduced in comparison to a conventional rapid start type.

### SUMMARY OF THE INVENTION

The present invention, having been conceived in light of the aforementioned problems, has an object of providing an arc tube of a novel structure, which can realize further reduction in size compared to a conventional straight-tube fluorescent lamp and is usable as an alternative thereto. The object of the present invention is also to provide a low-pressure mercury lamp and a lighting apparatus employing such an arc tube.

With the stated construction, when the luminous flux is set to be comparable to that of a conventional straight-tube fluorescent lamp, the arc tube will have about the same outer diameter as a conventional straight-tube fluorescent lamp, and further reduced length compared to a conventional straight-tube fluorescent lamp. As a result, the arc tube of the present invention, overall, is substantially smaller than a conventional straight-tube fluorescent lamp.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a perspective diagram of a fluorescent lamp being one embodiment of the present invention;

FIG. 2 is a diagram in which the fluorescent lamp of FIG. 1 is seen from the direction X;

FIG. 3 is a diagram in which the fluorescent lamp of FIG. 1 is seen from the direction Y;

FIG. 4 is a diagram depicting a relation between the lamp efficiency and the minimum distance Gt between two glass-tube portions that are within a winding part and are adjacent to each other in the direction of an axis;

FIG. 5 is a simplified diagram showing a lighting apparatus adopting a lamp according to the present invention, partly cut away to show its inside;

FIGS. 6A-6C are diagrams showing modification examples relating to the configuration of the arc tube.

FIG.7 is a diagram showing a modification example relating to the configuration of the arc tube;

FIGS. 8A and 8B are diagrams showing an example of an arc tube whose winding part is wound around an axis in a manner different from a circular manner; and

FIG. 9 is a diagram showing a modification example relating to a form of an end portion of the arc tube.

### DESCRIPTION OF THE PREFERRED EMBODIMENTS

The following describes a case where the present invention is applied to a fluorescent lamp that can alternate a conventional straight-tube fluorescent lamp of a rapid start type of 20 W and 40 W (a type of low-pressure mercury lamp), with reference to corresponding drawings. Needless to say, the present invention is applicable to an alternate to other types of straight-tube fluorescent lamp than the widely used straight-tube fluorescent lamp of a rapid start type of 20 W and 40 W.

1. Structure of Fluorescent Lamp

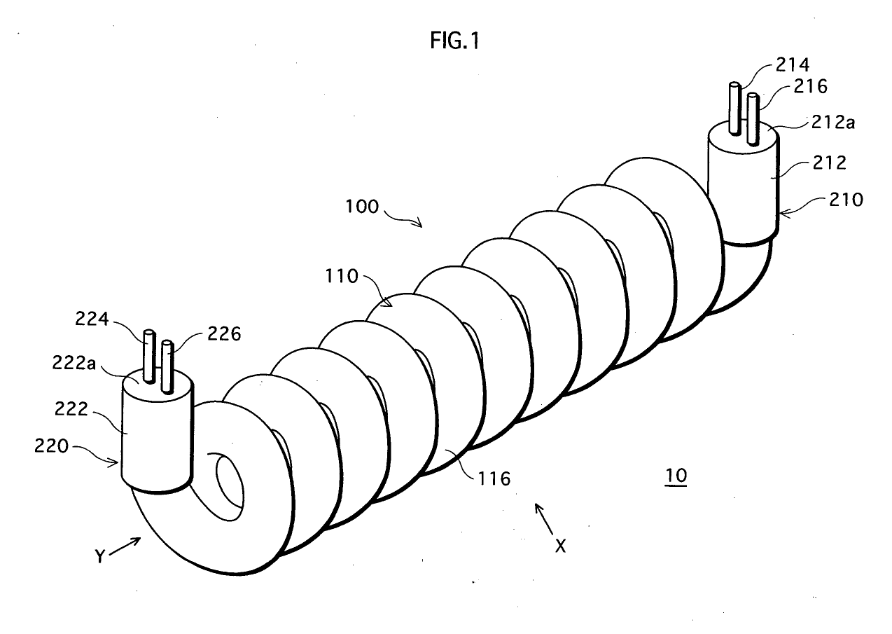

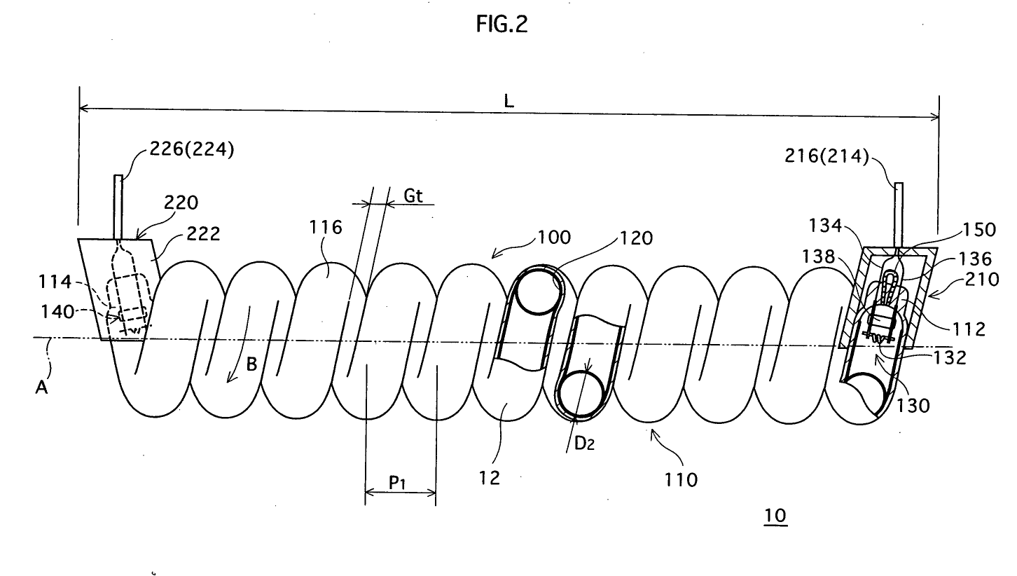

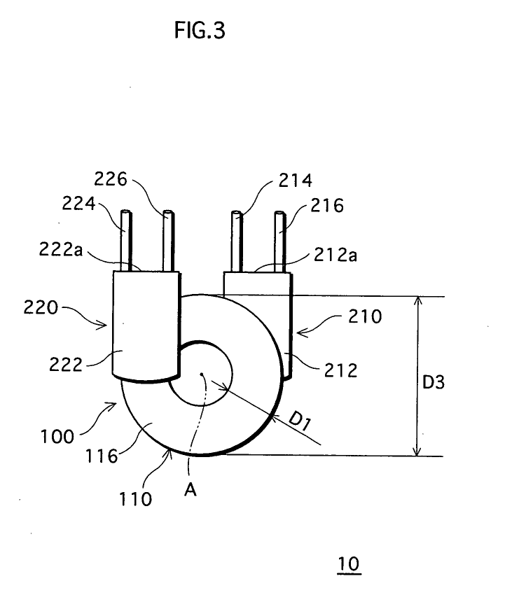

FIG. 1 is a perspective diagram of a fluorescent lamp being one embodiment of the present invention. FIG. 2 is a diagram in which the fluorescent lamp is seen from the direction X, and FIG. 3 is a diagram in which the fluorescent lamp is seen from the direction Y. Note that in FIG. 2, the fluorescent lamp is partly cut away so as to show the internal appearance thereof.

As shown in FIGS. 1-3, this fluorescent lamp 10 is made of an arc tube 100 and bases 210, 220. The arc tube 100 contains electrodes 130, 140 at respective ends 112, 114 of an arc-tube body 110 formed by a glass tube wound in helical configuration. The bases 210, 220 are provided at the respective ends of the arc tube 100 (i.e. at respective ends of the glass tube), and supply power to the electrodes 130, 140.

(1) Arc Tube

As FIGS.1-3 show, the arc tube 100 includes a helically configured arc-tube body 110 made of one glass tube winding around a predetermined axis A while moving into a predetermined direction (e.g. direction B in FIG. 2). Hereinafter, the part where the glass tube is wound is referred to as “winding part” and assigned a reference sign “116”. In addition, in the present specification, the axis of a winding part is a substantially straight line.

The arc-tube body 110 is configured so that ends thereof respectively extend in the direction of the normal to the circumference of a circle circling around the axis A. The bases 210, 220 are respectively provided at the extended parts of the arc-tube body 110.

The glass tube constituting the arc-tube body 110 is, for example, made of barium-strontium silicate glass (lead-free glass) whose transverse sectional form is substantially circular. Note that in the configuring process, a softened glass tube is helically wound to a jig. Accordingly, the transverse sectional form of the resulting glass tube will be slightly deformed from a regular circle.

As FIG. 2 shows, a phosphor 120 is applied on the inner surface of the arc-tube body 110 formed in the helical configuration.

The electrode 130 is in a so-called bead glass mounting method, and is made of: a tungsten coil electrode 132; a pair of lead wires 134 and 136 for supporting the coil electrode 132; and a beads glass 138 for fixing supportively the pair of lead wires 134 and 136. Although not shown due to the convenience of the drawing, the electrode 140 has the same structure as the electrode 130.

The part of the electrode 130 attached to the arc-tube body 110 is specifically part of the lead wires 134 and 136, and extends in the opposite side to the coil electrode 132 with respect to the beads glass 138.

In addition, at one end (end 112 in this example) of the arc-tube body 110, an exhaustion tube 150 is attached together with the electrode 130. This exhaustion tube 150 is employed to exhaust the air inside the arc-tube body 110, or to enclose thereto mercury and a buffer gas detailed later.

Mercury is sealed in a single form. Alternatively, an amalgam may be used, such as zinc mercury and tin mercury whose mercury vapor pressure characteristics at lamp startup are close to a case where mercury in a single form is used. Note that if a particular type of amalgam is used (e.g. an amalgam of bismuth, indium, and mercury), a mercury vapor pressure at lamp startup will become low, thereby worsening the luminous flux rising characteristics.

One example of the buffer gas is an argon gas. However, the buffer gas is not limited to an argon gas in a single form, but may be a mixture of rage gas (e.g. a mixture of argon and neon).

The bases 210 and 220 have cylindrical parts 211 and 212, respectively. Each of the cylindrical parts 211 and 212 is closed at one end. The base 210 also has a pair of pins 214 and 216 that elongate from an end wall 212a of the cylindrical part 212 into the orthogonal direction to the axis A. Likewise, the base 220 also has a pair of pins 224 and 226 that elongate from an end wall 222a of the cylindrical part 222 into the orthogonal direction to the axis A. As FIG. 2 shows, the pair of pins 214 and 216 are connected to the lead wires 134 and 136 of the electrode 130. Likewise, the pair of pins 224 and 226 are connected to the lead wires of the electrode 140 (not shown in the drawing).

2. Concrete Structure

The following describes the fluorescent lamp 10 in detail, with reference to FIGS. 2 and 3.

The fluorescent lamp 10 has substantially the same luminous flux as a straight-tube fluorescent lamp of a rapid start type of 20 W and 40 W. The fluorescent lamp 10 requires application of tube input of 16 W and 34 W, respectively. Note that the fluorescent lamp 10 is distinguished by “16 W type” and “34 W type”, in the present embodiment.

Inside the arc tube 100, mercury of 5 mg and argon of 400 Pa are respectively enclosed. In addition, the phosphor 120 is for example a three-wavelength type that contains three kinds of phosphors respectively emitting lights of red, green, and blue. Concrete materials are: red light (Y₂O₃:Eu); green light (LaPO₄:Ce, Tb); and blue light (BaMg₂Al₁₆O₂₇:Eu, Mn).

The arc-tube body 110 of 16 W type uses a glass tube having dimensions of: outer diameter D1 of 9.0 mm and inner diameter D2 of 7.4 mm. The arc-tube body 110 of 34 W type uses a glass tube having dimensions of: outer diameter D1 of 10.8 mm and inner diameter D2 of 9.2 mm. A pitch P1 of the winding part 116 in the direction parallel to the axis A (hereinafter this direction is referred to as “axis direction”) is respectively 8.0 mm and 21.6 mm (see FIG. 2). Hereinafter, this pitch P1 is called “winding pitch”. A minimum distance Gt between two glass-tube portions, which are within the winding part 116 and are adjacent to each other in the axis direction, is respectively 9.0 mm and 10.8 mm. Hereinafter, this minimum distance Gt is called “winding-part distance”. The total number of winding for the winding part 116 is 10 and 16, respectively.

The length L of the fluorescent lamp 10 (including the bases 210 and 220) is respectively 175 mm and 340 mm. The outer diameter D3 of the arc tube 100 seen in the linear-axis direction is respectively 27 mm and 32 mm. In addition, the between-electrode distance in the arc tube 100 is respectively 590 mm and 1040 mm, and the tube wall load is respectively 0.12 W/cm² and 0.11 W/cm².

Conventional straight-tube fluorescent lamps of rapid start type have length of 580 mm for 20 W type and 1198 mm for 40 W type, and outer diameter of the glass tube is 32.5 mm for the both types. In contrast, in the present embodiment, the fluorescent lamp 10 has length of 405 mm for 16 W type, and 858 mm for 34 W type, exhibiting substantial reduction in size.

The following describes performances of the fluorescent lamp 10. The fluorescent lamps 10 (16 W type and 34 W type) having the above-described structures were lit by applying tube input of 16 W and 34 W respectively, and with the bases 210, 220 being oriented upward. As a result, the 16 W type and the 34 W type developed total luminous flux of 1320 lm and 3450 lm, and exhibited lamp efficiency of 82.5 lm/W and 95.6 lm/W, respectively. In contrast, conventional straight-tube fluorescent lamps of rapid start type (20 W type and 40 W type) developed luminous flux of 1230 lm and 3450 lm, and exhibited lamp efficiency of 61.5 lm/W and 86.3 lm/W, respectively. In particular, the fluorescent lamps 10 of the present embodiment exhibits remarkable enhancement in lamp efficiency.

3. Manufacturing Method

The following briefly describes a manufacturing method of the arc tube 100.

The helical configuration of the arc-tube body 110 constituting the arc tube 100 is formed by winding one straight glass tube to a jig. The jig is in a columnar shape. An outer surface of the jig is provided with a groove having a shape corresponding to that of the helical configuration of the arc tube 100.

In the manufacturing method of the arc tube 100, a glass tube in straight-tube shape, from which the arc-tube body 110 is formed, is prepared first. Then a predetermined range of the glass tube, at least including a part scheduled to be the winding part 116, is heated to be softened. For the heating purpose, an electric furnace/a gas furnace, a heating apparatus using a gas burner, or the like, is employed. The glass tube is heated to be approximately 100° C. higher than the softening point thereof. Note that in the present embodiment, the glass tube is made of barium-strontium silicate glass whose softening point is about 675° C.

After the predetermined range of the glass tube is softened, an end portion of the glass tube is set and fixed to the jig described above. In this process of fixing, the end portion is set to the jig, and then air is blown to the end portion set to the jig, so as to cool and harden the end portion.

After the end portion of the glass tube has been fixed to the jig, the jig is rotated with the glass tube being tilted with respect to the axis of the jig. In this process, the softened portion of the glass tube is wound to the jig by being introduced into the groove.

After having been wound to the jig in helical configuration, the softened portion of the glass tube will be cooled (i.e. the entire glass tube will change from softened state into hardened state). Then, the wound glass tube is removed from the jig. This removing process is performed by rotating the jig into a direction opposite to the rotation direction in which the jig was rotated in the process of winding the glass tube to the jig.

After the removing process, unnecessary part of the glass tube is cut away. Then, an end portion of the glass tube from which the unnecessary part has been removed (i.e. from the very end of the glass tube to about half of the outer diameter D3 of the winding part 16), is heated using a gas burner for example, so as to bend the end portion into a direction of the normal (see FIG. 3). As a result, the arc-tube body 110 in helical configuration is completed for use as the arc tube 100.

Then, the phosphor 120 is applied to the inner surface of the arc-tube body 110. The electrode 130 and the exhaustion tube 150 are attached to the end 112 of the arc-tube body 110, and the electrode 140 is attached to the end 114 of the arc-tube body 110. After the air is exhausted from the arc-tube body 110 via the exhaustion tube 150, mercury and rare gas are enclosed. Then the tip of the exhaustion tube 150 is sealed using a chip-off method, thereby completing the arc tube 100.

4. Lamp Efficiency

The inventors attempt to create a fluorescent lamp whose length is shorter than conventional straight-tube fluorescent lamps, by forming the arc tube in helical configuration. By reducing the winding pitch P1 of the winding part of the arc-tube body in helical configuration, further reduction in size of the fluorescent lamp becomes possible. However, the inventors have feared that reduction in the winding pitch, although being instrumental in achieving shorter length for the fluorescent lamp, might cause the winding part 116 to have shortened winding-part distance, thereby causing the light from the arc tube 100 to be trapped within the winding part 116, to lead to degraded lamp efficiency.

In view of the above, a test was conducted as to lamp efficiency effect of the winding-part distance in the winding part 116. Here, arc tubes used in the test were respectively formed by winding one glass tube described in the former-described section “2. Concrete structure”, and has a winding pitch different from the winding pitch P1. Needless to say, the length of the arc tube changes depending on the winding pitch.

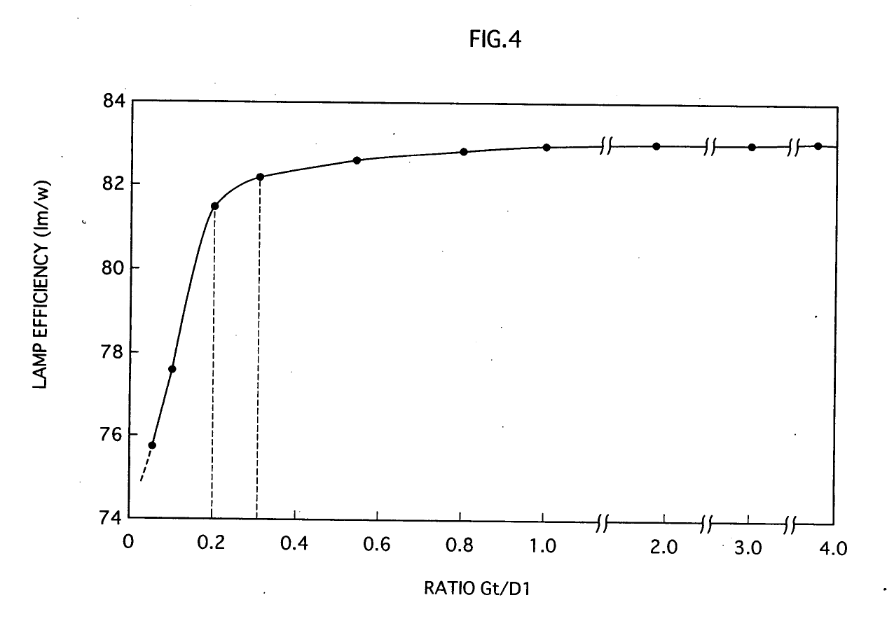

In the test, fluorescent lamps whose winding parts have different pitches from each other were lit at room temperature (i.e. 25° C.) and total luminous flux was measured for each of the fluorescent lamps by applying tube input of 16 W. FIG. 4 shows the lamp efficiency calculated using thus measured total luminous flux. In FIG. 4, the vertical axis represents lamp efficiency, and the horizontal axis represents a ratio of the winding-part distance to the outer diameter of the glass tube (this ratio is hereinafter represented as “Gt/D1”).

In FIG. 4, when “Gt/D1” takes values in the range of 0.0 to 0.2, the lamp efficiency improves rapidly as the value of “Gt/D1” increases. When “Gt/D1” takes values in the range of 0.2 to 0.8, the lamp efficiency gradually improves as the value of “Gt/D1” increases. When “Gt/D1” takes 0.8 or larger values, the lamp efficiency does not increase much even if the value of “Gt/D1” increases.

The above test result shows that it is preferable that “Gt/D1” takes a value greater than 0.2, with more preferable range being equal to or greater than 0.3. Note that it is not desirable if “Gt/D1” becomes greater than 2.0, because the length of the fluorescent lamp becomes too long whereas the lamp efficiency hardly increases in the range greater than 2.0.

5. Lighting Apparatus

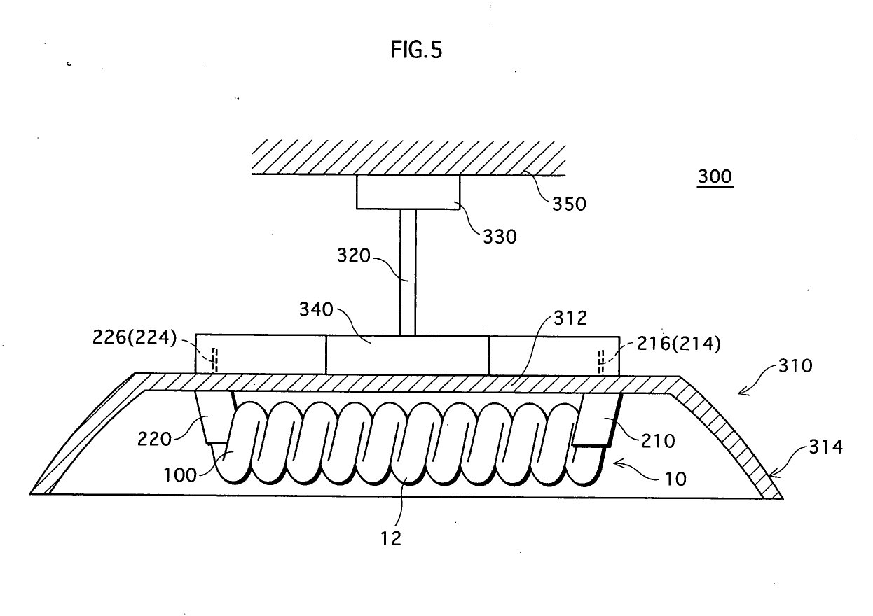

FIG. 5 is a simplified diagram showing a lighting apparatus adopting a fluorescent lamp according to the present invention. In the diagram, the lighting apparatus is partly cut away so as to show its inside.

The lighting apparatus 300 adopts the fluorescent lamp 10 of 16 W type being described above.

As this diagram shows, the lighting apparatus 300 is a pendant type for example, and includes an apparatus body 310, a cable 320 for supplying power to the apparatus body 310, and a socket 330 that is removably fixed to a rosette provided at a ceiling 350, the socket 330 hanging the apparatus body 310 via the cable 320.

The apparatus body 310 has a shade 314 having a flat bottom 312 at its substantial center, a fluorescent lamp 10 removably fixed to the bottom 312 inside the shade 314, and a lighting circuit 340 provided outside the shade 314 at the bottom 312, the lighting circuit 340 storing therein an electronic ballast being for lighting the fluorescent lamp 10.

The bases 210 and 220 of the fluorescent lamp 10 are connected to sockets (not shown) of the apparatus body 310 with the axis of the arc tube 100 being oriented in the horizontal direction. As a result, the fluorescent lamp 10 is removably fixed to the bottom 312 and is electrically connected to the lighting circuit 340.

Note that the electronic ballast is in a series inverter method for high frequency, and is comprised of various electronic parts (not shown in the drawing) such as a choke coil, an electrolytic capacitor, a resonant capacitor, and a switching device.

The inner surface of the shade 314, for example, functions as a reflective surface, and reflects light emitted from the fluorescent lamp 10 into a desired direction (into a downward direction to illuminate the lower side). This reflective surface is formed by applying white paint or alumina particles, for example.

When the electronic ballast lights the fluorescent lamp 10, the tube wall temperature at a center part 12 (see FIG. 5) of the arc tube 10 will reach about 60° C.-65° C. The center part 12 will be the coldest spot of the entire inside wall of the tube. At this tube wall temperature, the mercury vapor pressure in the arc tube 100 under the lamp's steady lighting state gives maximum range of lamp efficiency. The details are given later.

### MODIFICATION EXAMPLES

So far, the present invention has been described based on the embodiment. However needless to say, the contents of the present invention should not be limited to the concrete example shown by way of the embodiment. For example, the following modification examples are also possible.

1. With Regard to Overall Configuration of Arc Tube

In the embodiment, the arc tube 100 has such a configuration wound around the axis in a certain direction except for the bases 210 and 220. However, the present invention is not limited to such a configuration. Specifically, the present invention may be in other configurations as long as the arc-tube body 110 constituting the arc tube 100 has a winding part 116 that is wound around an axis, and the ends (112 and 114) of the arc-tube body 110 are positioned away from each other in the axis direction with the winding part 116 therebetween.

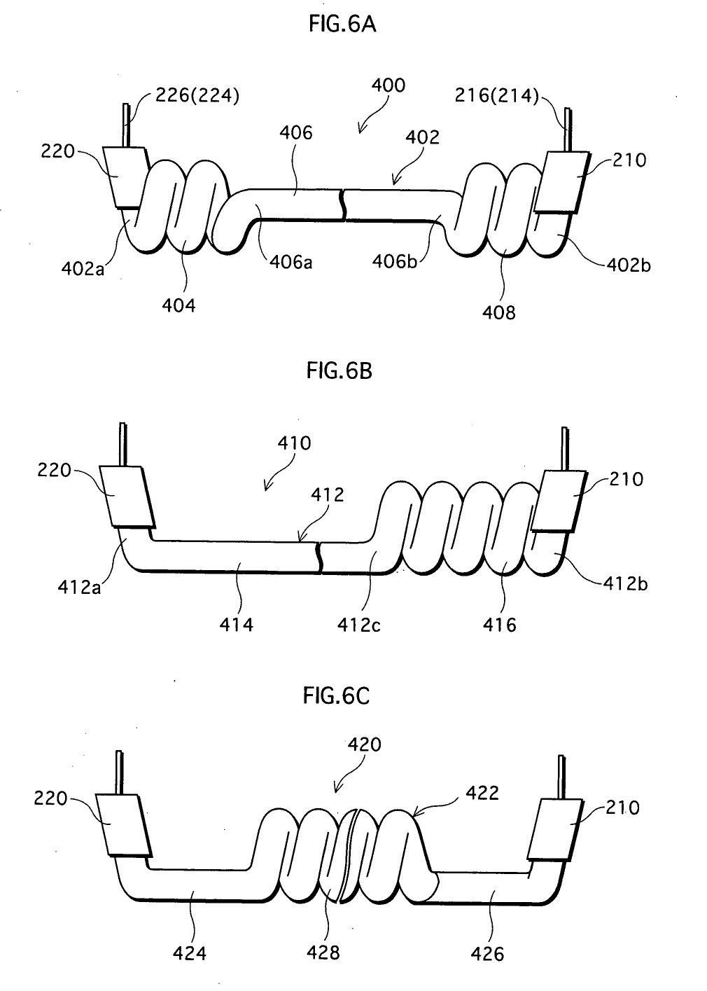

FIGS. 6A-6C are diagrams showing modification examples relating to the configuration of the arc tube. Note that the components or the like that have the same structure as the embodiment are assigned the identical reference signs.

### (a) First Example (FIG. 6A)

In the first example, an arc tube 400 has a straight-tube part 406 formed in the middle of a glass tube 402. Further, the arc tube 400 has two winding parts 404 and 408 that are respectively wound around an axis. The winding part 404 corresponds to a part of the glass tube 402 from an end 406a of the straight-tube part 406 to an end portion 402a of the glass tube 402. Likewise, the winding part 408 corresponds to a part of the glass tube 402 from an end 406b of the straight-tube part 406 to an end portion 402b of the glass tube 402.

### (b) Second Example (FIG. 6B)

The arc tube 400 in the first example has the straight-tube part 406 in the middle, and the winding parts 404 and 408 at the sides of the straight-tube part 406 respectively. In contrast, an arc tube 410 of the second example has a straight-tube part 414 from one end portion 412a of a glass tube 412 to a predetermined position 412c. Accordingly, a winding part 416 of the second example corresponds to a part of the glass tube 412 from the predetermined position 412c to the other end portion 412b.

### (c) Third Example (FIG. 6C)

The arc tube 400 in the first example has the straight-tube part 406 in the middle, and the winding parts 404 and 408 at the sides of the straight-tube part 406 respectively. In reverse, the arc tube 420 of the third example has a winding part 428 in the middle of a glass tube 422, and straight-tube parts 424 and 426 at the sides of the winding part 428 respectively.

### (d) Summary of the First to Third Examples

The arc tubes 400, 410, and 420, described above, will be longer than the arc tube 100 of the first embodiment. However, the first example enables the brightness to be higher at the end portions of the arc tube 400 than at the middle. This will allow higher level of flexibility in design of length and watts. In addition, various lighting scenes can be created by using fluorescent lamps having winding parts placed in different positions to each other.

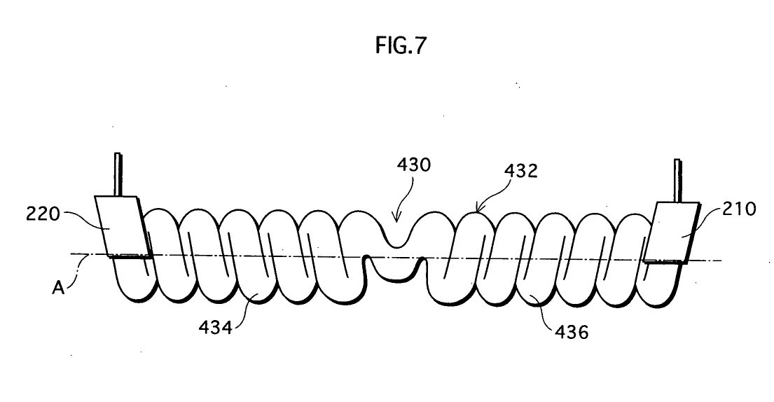

### (e) Fourth Example (FIG. 7)

FIG. 7 is a diagram showing a modification example relating to the configuration of the arc tube. Note that the components or the like that have the same structure as the embodiment are assigned the identical reference signs, also in this example.

In all the embodiment and the first to third examples, the arc tubes 100, 400, 410, and 420 respectively have a configuration of being wound in one direction around the axis A. In the fourth embodiment, on the contrary, an arc tube 430 has a configuration such that a glass tube constituting the arc tube 430 has two winding parts wound around the axis A in reverse directions to each other. More specifically, the arc tube 430 is configured so that an arc-tube body 432 includes: a first winding part 434 that is wound around the axis A in a first direction; and a second winding part 436 that is wound around the axis A in a second direction that is reverse to the first direction. Note that the fourth example has two winding parts (434 and 436), however, may have more winding parts.

The arc tube 430, having the above-described configuration, is formable by using two jigs respectively for the first winding part 434 and the second winding part 436.

2. With Regard to Arc-Tube Body

(a) Winding Part

In the embodiment, the winding part 116 of the arc-tube body 110 is wound in a circular manner around the axis A. More specifically, seen in the liner axis direction, the circumferential surface of the winding part 116 of the arc-tube body 110 forms a circle. However, the present invention is not limited to cases where a winding part is wound around an axis in the circular manner.

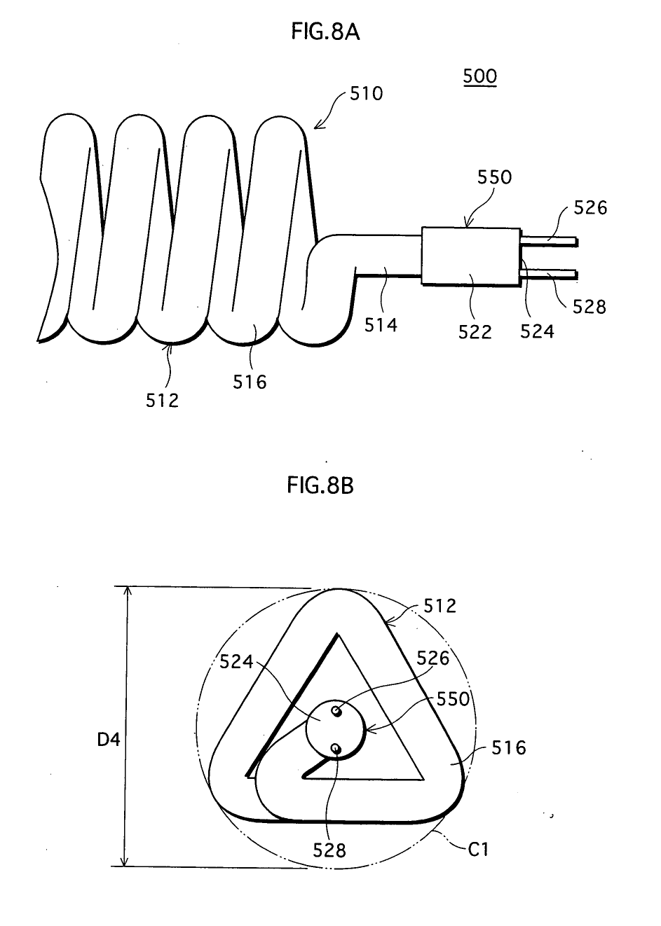

FIGS. 8A and 8B are diagrams showing an example of an arc tube whose winding part is wound around an axis in a manner different from the circular manner.

In FIG. 8A, the fluorescent lamp is seen in the direction orthogonal to the axis, whereas in FIG. 8B, the fluorescent lamp is seen in the axis direction.

As FIG. 8 shows, the fluorescent lamp 500 has an arc tube 510 and a base 550. An arc-tube body 512 for use as the arc tube 510 includes a winding part 516 being wound around the axis in a triangular manner. More specifically, the circumferential surface of the winding part 516 seen in the axis direction forms a triangle

Note that the winding part 516 may be wound around the axis in other manners than the triangular manner. In addition, so as to enable a winding part to have the aforementioned configuration, the jig is required to have a disassemblable structure.

When a fluorescent lamp is in the form of a regular triangle seen in the axis direction, “an outer diameter of a winding part” indicates a diameter D4 of a circum circle C1 circum scribing the regular triangle (See FIG. 8B). Likewise, when a fluorescent lamp is in the form of a regular polygon seen in the axis direction, the “an outer diameter of a winding part” indicates a diameter of a circum circle circumscribing the regular polygon.

When a fluorescent lamp is in the form of other than the regular polygon (i.e. is in non-circular form) seen in the axis direction, “an outer diameter of a winding part” corresponds to a distance between two points on the circumferential surface of the winding part, the two points being farthest to one another. For example, when a fluorescent lamp is in the form of an oval seen in the axis direction, “an outer diameter of a winding part” indicates a long diameter of the oval.

As FIG. 8A shows, an end portion 514 of the arc-tube body 512 elongates in the axis direction. A base 550 is fixed to the tip of the end portion 514. The base 550 includes a cylindrical part 522 and a pair of pins 526 and 528, the pair of pins 526 and 528 elongating in the axis direction from an end wall 524 of the cylindrical part 522, just as in the embodiment.

It should be noted that if the end portion 514 of the arc-tube body 512, to which the base 550 is fixed, elongates in the axis direction, as in FIGS.8A, the fluorescent lamp will have a similar structure as those for conventional straight-tube fluorescent lamps. Accordingly, a lighting apparatus for which such a fluorescent lamp is used will also have a structure similar to conventional lighting apparatuses.

(b) Form of End Portion

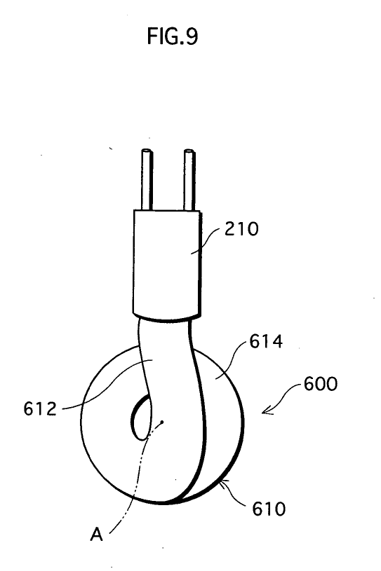

As in the embodiment, the end portion of the arc-tube body in the first modification example elongates in the direction orthogonal to the axis. However, the present invention is not limited to such a structure. For example, the end portion of the arc-tube body may elongate in the axis direction. FIG. 9 shows still another example. In this example, the end portion 612 of the arc-tube body 610 traverses the center of the winding (i.e. axis A) to elongate in a predetermined direction (upward direction in FIG. 9). Further, the base 210 is positioned outside the circumferential surface of the winding part 614. If the base 210 is positioned outside the circumferential surface of the winding part 614 (upward direction in FIG. 9) as in the above way, the base 210 does not obstruct the light emitted in the axis direction when the fluorescent lamp 600 is lit, and so total luminous flux will improve.

(c) Outer Diameter of Winding Part

In the arc-tube body 110 for 16 W type and 34 W type described in the embodiment, the outer diameter D3 of the winding part 116 is respectively 27 mm and 32 mm. However, it is sufficient that the outer diameter D3 be in a range of 16 mm to 38 mm, inclusive. The following explains the reason for this.

When actually used, the fluorescent lamp of the aforementioned structure should look normal as an alternative to a conventional straight-tube fluorescent lamp, and accordingly the outer diameter of its arc tube should be within a certain range. In view of this, the inventors conducted a test to examine a desirable range of the outer diameter.

In the test, various helixes were formed using glass tubes respectively having an outer diameter of 9.0 mm just as in the embodiment. Then subjective evaluations were conducted as to whether the helixes would look normal if used as an alternative to an arc tube of a straight-tube fluorescent lamp.

As a result, the desirable outer diameter turned out to be in a range of 16 mm to 38 mm, inclusive, as described above, so that a resulting lamp be perceived as an alternative to a straight-tube fluorescent lamp.

In the mentioned range, the upper limit value 38 mm corresponds to an outer diameter of an arc tube for a straight-tube fluorescent lamp of a rapid start type originally in wide use. Even today, this type of arc tube is used for a 110 W type.

The lower limit value 16 mm corresponds to a minimum value of outer diameter of a winding part formable in an arc-tube body 110 having a minimum tube outer diameter. The further details are given later in the following section describing the outer diameter D1 of a glass tube constituting the arc-tube body 110.

(d) Outer Diameter of Glass Tube

In the above-stated embodiment, the outer diameters D1 of glass tubes constituting the arc-tube bodies respectively for 16 W type and 34 W type are 9.0 mm and 10.8 mm. However, the outer diameter D1 may be in a range of 6.0 mm to 0.38*D3 mm, where D3 is an outer diameter of the helical configuration of the arc-tube body (i.e. outer diameter of winding part). The following describes the reason for setting the outer diameter of the glass tube within the above range.

If the outer diameter D1 of the glass tube takes a value smaller than 6.0 mm, the mechanical strength of a resulting arc-tube body 110 will decrease, leading to breakage in transfer and conveyance. Furthermore, it becomes difficult to provide electrodes in an arc-tube body (glass tube) having such a tube diameter. As a result, commercialization thereof is difficult.

On the other hand, if the outer diameter D1 takes a value larger than a product obtained by multiplying an outer diameter D3 of a winding part by 0.38, the ratio of a glass tube to the outer diameter of a winding part becomes too high, making it difficult to form a winding part having a desirable outer diameter.

As already described above, the upper limit value of the outer diameter D3 of the winding part 116 is defined as 38 mm. In view of this, the outer diameter D1 of the glass tube has to be in the range of 6.0 mm to 14.4 mm, inclusive.

(e) Tube-Wall Load

In development of the present fluorescent lamp, the inventors examined an optimal range of tube wall load for the arc tube. The reason is as follows. The lamp efficiency at the lighting time is affected by a mercury vapor pressure uniquely defined by the tube wall temperature at the coldest spot of the arc tube (hereinafter simply referred to as “coldest-spot temperature”). More specifically, the maximum range of lamp efficiency is obtained at an optimal range of mercury vapor pressure uniquely defined by the coldest-spot temperature. The coldest-spot temperature of an arc tube is defined mainly by tube wall load. As a result, optimization of tube wall load is necessary so as to enhance lamp efficiency. Note that it is widely known that an optimal range of coldest- spot temperature increases as the inner diameter of the glass tube constituting the arc tube decreases.

From the above reason, the inventors have set the inner diameter of the glass tube in a range of 4.4 mm to 12.8 mm, in accordance the range of the outer diameter D1 described above (i.e. the range of 6.0 mm to 14.4 mm). Here, the typical thickness of the glass tube is assumed to be 0.8 mm. Under these conditions, the coldest-spot temperature of the arc tube that can produce the optimal mercury vapor pressure was examined, and turned out to be approximately 55° C.-65° C.

Meanwhile, the present fluorescent lamp has to obtain substantially the same luminous flux as the straight-tube fluorescent lamp of a conventional rapid start type. In view of this, in a test to examine the relationship between the tube wall load and the lamp efficiency, the between-electrode distance is varied while maintaining the ratio of Gt/D1 as 1.0 for the purpose of varying the tube wall load. The test result shows that an optimal range for the tube wall load is 0.07 W/cm² to 0.16 W/cm².

Note that it is already known that the lamp's life gets long as the tube wall load decreases. With respect to this point, a test result reveals that a lamp with the optimal range of the tube wall load has at least the same level of life time as a conventional straight-tube fluorescent lamp.

(f) Form of Glass Tube

In all the embodiment and the modification examples, the transverse sectional form of the glass tube is substantially circular. However the present invention is not limited to such a transverse sectional form. For example, the transverse sectional form of the glass tube may be oval.

The following describes how to define a winding-part distance for an arc tube whose glass tube's transverse sectional form is oval. When the long diameter of the glass tube is Da, and the short diameter is Db, the winding-part distance can be obtained using the value of “(Da+Db)/2” in place of the value of “D1”. Specifically, the winding-part distance Gt should be set so that the Gt/{(Da+Db/2)} will satisfy the following relation.
0.2<Gt/{(Da+Db)/2}≦2.0

One method of creating an oval transverse sectional form of a glass tube is to make a jig whose groove's transverse sectional form is oval.

3. Other Matters

The lamp described in the embodiment has luminous flux equivalent to straight-tube fluorescent lamps of a conventional rapid start type of 20 W and 40 W. However, the lamp of the present invention can also be used as an alternative to other straight-tube fluorescent lamps than a 20 W type or a 40 W type. In such a case, it becomes necessary to equalize the total luminous flux of the lamp to a corresponding straight-tube fluorescent lamp. For this purpose, it is convenient to use the helical arc tube having the above-described structure, because it is possible to change the between-electrode distance of the arc tube without changing the tube diameter of the glass tube constituting the arc tube.

Accordingly, when the present invention is used for the purpose of replacing several different types of conventional straight-tube fluorescent lamps, it is sufficient to change only the length of arc tubes without changing the tube diameter of glass tubes respectively constituting the arc tubes. If a glass tube's tube diameter can be uniform among different arc tubes, it is quite instrumental in achieving commonality of the electrode mounting to be provided at the ends of an arc-tube body, or for achieving commonality of the inverter circuit for a ballast, because electric currents among lamps while being lit can be made uniform.

4. With Respect to Phosphors

The above embodiment only describes a case where the present invention is applied to a so-called fluorescent lamp, whose arc tube contains phosphors applied on the inner surface of the arc tube. The present invention, however, is also applicable to an arc tube that does not contain phosphors on an inner surface thereof, or to a lamp employing such an arc tube. In other words, the present invention is applicable to an arc tube for a low-pressure mercury lamp, or to a low-pressure mercury lamp.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

1. An arc tube comprising:
an arc-tube body being made of a glass tube and including at least one winding part formed by helically winding part of the glass tube around an axis, ends of the glass tube being positioned away from each other with the winding part therebetween in the axial direction; and
electrodes provided at respective ends of the arc-tube body, wherein an outer diameter of the winding part seen in the axial direction is within a range of 16 mm to 38 mm, inclusive.

2. The arc tube of claim 1, wherein
in the winding part, the glass tube is wound around the axis with a constant radius.

3. The arc tube of claim 1, wherein
when an outer diameter of the winding part is D3 (mm), an outer diameter D1 (mm) of the glass tube satisfies 6.0 mm≦D1≦D3*0.38 mm.

4. The arc tube of claim 2, wherein
when an outer diameter of the winding part is D3 (mm), an outer diameter D1 (mm) of the glass tube satisfies 6.0 mm≦D1≦D3*0.38 mm.

5. The arc tube of claim 1, wherein
in the winding part, the glass tube is wound a plurality of times, and a minimum distance Gt (mm) between two glass-tube portions in-the winding part that are adjacent in the axial direction satisfies 0.2<Gt/D1≦2.0 when an outer diameter of the glass tube is D1 (mm).

6. The arc tube of claim 4, wherein
in the winding part, the glass tube is wound a plurality of times, and a minimum distance Gt (mm) between two glass-tube portions in the winding part that are adjacent in the axial direction satisfies 0.2<Gt/D1≦2.0 when an outer diameter of the glass tube is D1 (mm).

7. A low-pressure mercury lamp comprising:
an arc tube formed by an arc-tube body and electrodes provided at respective ends of the arc-tube body;
bases respectively provided at ends of the arc tube and supplying power to the electrodes, wherein
the arc-tube body includes a winding part formed by helically winding part of the glass tube around an axis, ends of the glass tube is positioned away from each other with the winding part therebetween in the axial direction, and an outer diameter of the winding part seen in the axial direction is within a range of 16 mm to 38 mm, inclusive.

8. The low-pressure mercury lamp of claim 7, wherein
in the winding part, the glass tube is wound around the axis with a constant radius.

9. The low-pressure mercury lamp of claim 7, wherein
when an outer diameter of the winding part is D3 (mm), an outer diameter D1 (mm) of the glass tube satisfies 6.0 mm≦D1≦D3*0.38 mm.

10. The low-pressure mercury lamp of claim 9, wherein
when an outer diameter of the winding part is D3 (mm), an outer diameter D1 (mm) of the glass tube satisfies 6.0 mm≦D1≦D3*0.38 mm.

11. The low-pressure mercury lamp of claim 7, wherein
in the winding part, the glass tube is wound a plurality of times, and a minimum distance Gt (mm) between two glass-tube portions in the winding part that are adjacent in the axial direction satisfies 0.2<Gt/D1≦2.0 when an outer diameter of the glass tube is D1 (mm).

12. The low-pressure mercury lamp of claim 10, wherein
in the winding part, the glass tube is wound a plurality of times, and a minimum distance Gt (mm) between two glass-tube portions in the winding part that are adjacent in the axial direction satisfies 0.2<Gt/D1≦2.0 when an outer diameter of the glass tube is D1 (mm).

13. The low-pressure mercury lamp of claim 7, wherein
tube wall load of the arc tube is in a range of 0.07 W/cm² to 0.16 W/cm², inclusive.

14. The low-pressure mercury lamp of claim 12, wherein
tube wall load of the arc tube is in a range of 0.07 W/cm² to 0.16 W/cm², inclusive.

15. A lighting apparatus comprising a low-pressure mercury lamp of claim 7.

16. A lighting apparatus comprising a low-pressure mercury lamp of claim 14.
